(19) United States
(12) Patent Application Publication
(10) Pub. No.: US 2007/0122612 A1
(43) Pub. Date: May 31, 2007

(54) PAINT SWATCH

(76) Inventors: Virginia L. Young, Portland, OR (US); Jane A. Lowe, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/565,606

(22) Filed: Nov. 30, 2006

Related U.S. Application Data
(60) Provisional application No. 60/741,134, filed on Nov. 30, 2005.

(51) Int. Cl. B32B 7/12; B32B 15/04; B32B 29/00

(52) U.S. Cl. 428/343; 428/354; 428/537.5

(57) ABSTRACT

Embodiments of the present invention include but are not limited to methods and apparatus for sampling paint and related products. In exemplary embodiments of the present invention, a repositionable swatch may be employed to facilitate a user in evaluating a paint sample on one or more target locations.

### CROSS REFERENCE TO RELATED APPLICATIONS

The present application claims priority to U.S. Provisional Patent Application No. 60/741,134, filed Nov. 30, 2005, entitled “Paint Swatch,” the entire contents of which are hereby incorporated by reference in their entirety.

### TECHNICAL FIELD

Embodiments of the present invention relate to the field of paint and related products, and in particular to methods and apparatuses for facilitating a user in choosing paint or similar products.

### BACKGROUND

Current techniques for sampling paint and paint colors generally involve using colored chips or cards. Such colored chips are generally small and do not comprise the actual paint being considered. Thus, it is difficult for a user to evaluate characteristics of a prospective paint, such as color, texture and sheen, using such colored chips or cards. Other current techniques for sampling paint include brushing a small sample of paint on the target location. Such techniques, however, are generally inconvenient and often wasteful. Accordingly, a need exists for an improved way of facilitating a user in choosing paint and paint colors.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a simplified diagram illustrating a swatch in accordance with an embodiment of the present invention.

### DETAILED DESCRIPTION OF EMBODIMENTS OF THE INVENTION

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The description may use perspective-based descriptions such as up/down, back/front, and top/bottom Such descriptions are merely used to facilitate the discussion and are not intended to restrict the application of embodiments of the present invention.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the invention, a method and apparatus for sampling paint is provided. More specifically, in an embodiment of the present invention, a method and apparatus for sampling house paint is provided. In exemplary embodiments of the present invention, a repositionable swatch may be employed to facilitate a user in evaluating a paint sample on one or more target locations. In such an embodiment, the one or more target locations may, for example, be on walls, cabinets, floors, or pieces of furniture. In an embodiment of the present invention, the repositionable swatch may, for example, be coated with real paint, as opposed to being prints of color. In the following description, unless further particularized or otherwise noted, the term “swatch” is intended to refer broadly to any material used to represent or sample paint. In other embodiments, samples other than paint may be utilized, such as wallpaper.

In embodiments, the material used for a swatch substrate may be specifically selected to have or to mimic the characteristics of the surface on which the swatch is intended to be applied. For example, a swatch may be intended to be applied on a wall constructed of plaster or drywall, or a wooden surface such as a deck or porch. In such situations, a substrate may be selected to have the characteristics of the intended surface, for example, integrating an element of the wood grain if intended to be used on a wooden surface or the absorptive texture/surface of drywall if that is the intended surface. In an embodiment, a substrate material may be used having a texture substantially similar to stucco, concrete, wood, drywall, plaster, paper, glass, metal, or fabric.

In an embodiment of the present invention, a device for sampling paint may comprise a substrate (such as constructed from paper, canvas, plastic, cardboard, or poster board) having a first surface and a second surface, and an adhesive or other repositionable mounting means coupled to the second surface, wherein the first surface may be coated with a sample material. In an embodiment, a repositionable mounting means may be constructed from velcro or a fabric, which provides a mechanism for attachment to the fabric portions of furniture without damaging the upholstered fabric.

In an embodiment, a paper substrate may be utilized that resists buckling of the paper after the sample paint has been applied. Such paper may be specifically selected for such characteristics, in particular for having a particular internal strength and resistance to excessive absorption of solutions in the paint or sample.

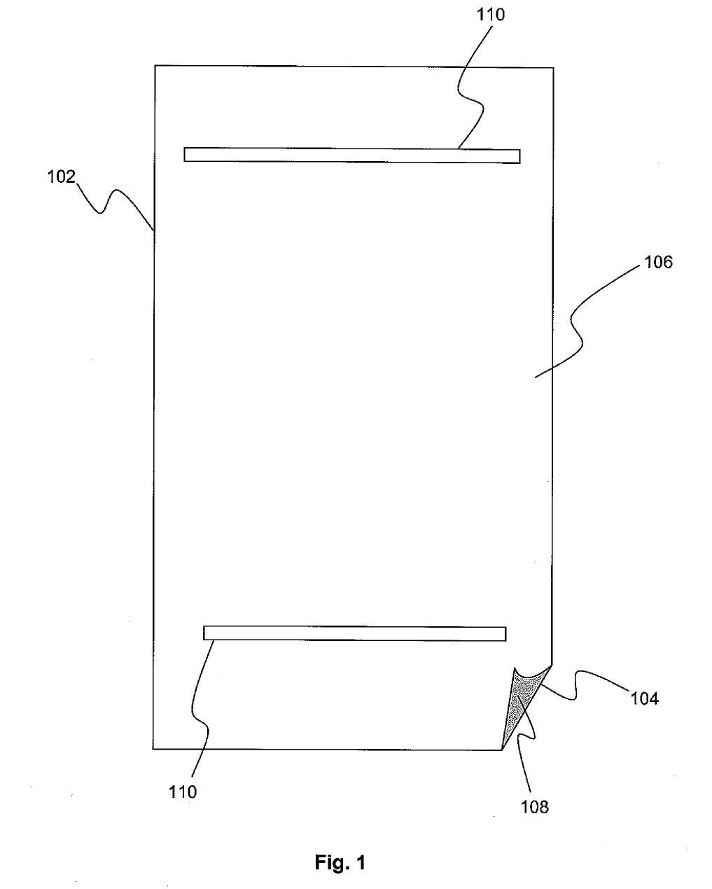

Referring now to FIG. 1, wherein a simplified diagram illustrating various embodiments of the present invention is shown. As illustrated, substrate (or sheet) 102 may be provided. In various embodiments of the present invention, substrate 102 may have a first surface 104 and a second surface 106. In an embodiment of the present invention, substrate 102 may comprise a flexible material, such that substrate 102 may be flexed or rolled without damaging the applied sample or the underlying substrate. In an embodiment, substrate 102 may comprise paper or canvas. In another embodiment of the present invention substrate 102 may comprise plastic. In an embodiment of the present invention, substrate 102 may comprise a rigid material. In such an embodiment, for example, substrate 102 may comprise cardboard or poster board.

In an exemplary embodiment of the preset invention, the length of substrate 102 may be about 6 or more inches. More specifically, in an embodiment of the present invention, the length of substrate 102 may be in a range of about 6 to 60 inches. In another embodiment, the width of substrate 102 may be about 6 or more inches. More specifically, in an embodiment of the present invention, the width of substrate 102 may be in a range of about 6 to 60 inches.

In a preferred embodiment of the present invention, an oversized substrate may be provided that is sufficiently large to eliminate or reduce the negative optical effect of the surrounding surface on which the swatch is applied or against which the swatch is compared. Such an embodiment addresses the phenomenon that the size of the area that any color occupies determines the color effect and thus the color perception by an individual. Conventional swatches are small in size and encounter a dramatic color shift due to ambient light effects and color pollution (i.e., color bleeding) from the reflectivity of surrounding surfaces. Thus, an embodiment of the present invention provides a substrate having a surface area sufficient to achieve a true color characteristic of the substrate when a sample material is applied to the substrate and the substrate is coupled to a mounting surface. The term “mounting surface” refers to the surface on which the sample is being tested, for example a wall for which a paint color is being considered. The term “true color characteristic” refers to the perceived color of the sample material by an individual in various lighting conditions on a variety of surfaces, the perceived color being the intended color absent any or at least substantially reduced color pollution effect.

In such an embodiment, an oversized substrate may be approximately 22 inches wide by 27 inches long. In another embodiment, an oversized substrate may be approximately 60 inches wide by 60 inches long. In embodiments, an oversized substrate may have a surface area on one surface of greater than 600 square inches, for example approximately 600-700 square inches. Using an oversized substrate eliminates or reduces the color pollution effect as discussed above because the light (color) perceived by an individual is substantially a product of the light reflected from the sample on the substrate as opposed to substantially impacted by the color of the surrounding surface(s).

Thus, in an embodiment there is provided an oversized, repositionable paint swatch comprising a substrate having a first surface and a second surface, the first surface having a surface area sufficient to achieve a true color characteristic of a sample material when the sample material is applied to the first surface and the substrate is coupled to a mounting surface, a sample material applied to the first surface, and a repositionable mounting means disposed on the second surface and adapted to repositionably couple the substrate to the mounting surface.

In various embodiments of the present invention, a sample material 108 may be applied to first surface 104. In an embodiment of the present invention, sample material 108 may comprise paint. In such an embodiment, sample material 108 may comprise latex paint or water-based lacquer paint. For example, sample material 108 may comprise a sample of the actual paint that a user may be considering applying to a target surface. In an embodiment of the present invention, sample material 108 may comprise a paint having a color that a user may be considering for a target surface. In embodiments, a target surface may be a wall, a piece of furniture, a cabinet, a floor, etc.

In an embodiment of the present invention, an adhesive 110 may be attached to second surface 106. In various embodiments of the present invention, adhesive 110 may comprise adhesive tape. In another embodiment, adhesive 110 may comprise glue. In an embodiment of the present invention, adhesive 110 may cover substantially all of second surface 106. In another embodiment, adhesive 110 may comprise one or more strips of adhesive material. In another embodiment, adhesive 110 may comprise one or more spots of adhesive material. In another embodiment of the present invention, adhesive 110 may be sprayed on to second surface 106. In an embodiment, the entire surface on which an adhesive is applied may be coated with an adhesive to provide a substrate that may be pressed flat against a desired mounting surface. In various embodiments, a release paper or release liner may be present on the adhesive, which may then be removed prior to use and replaced on the adhesive portion after use, if desired.

In an embodiment of the present invention, adhesive 110 may be adapted to allow a user to affix substrate 102 to one or more sample locations. In various embodiments of the present invention, the one or more sample locations may be located on one or more walls, pieces of furniture, or cabinets. In various embodiments of the present invention, the one or more sample locations may be located on one or more surfaces that the user may be considering painting.

In various embodiments of the present invention, adhesive 110 may be reusable. In an embodiment of the present invention, adhesive 110 may be adapted to allow a user to affix sheet 102 to a first sample location and then detach sheet 102 from the first sample location and affix sheet 102 to one or more additional sample locations. Thus, in an embodiment of the present invention, adhesive 110 may assist a user in evaluating the desirability of certain paints at one or more locations by allowing the user to reposition sheet 102 one or more times without damaging the underlying target surface.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein.

What is claimed is:

1. An oversized, repositionable paint swatch comprising:
a substrate having a first surface and a second surface, the first surface having a surface area sufficient to achieve a true color characteristic of a sample material when the sample material is applied to the first surface and said substrate is coupled to a mounting surface;
a sample material applied to the first surface; and
a repositionable mounting means disposed on the second surface and adapted to repositionably couple the substrate to the mounting surface.

2. The swatch of claim 1, wherein said substrate has a width of about 60 inches and a length of about 60 inches.

3. The swatch of claim 1, wherein said substrate has a width of about 22 inches and a length of about 27 inches.

4. The swatch of claim 1, wherein the surface area is greater than 600 square inches.

5. The swatch of claim 4, wherein the surface area is about 600-700 square inches.

6. The swatch of claim 1, wherein the substrate comprises a flexible material.

7. The swatch of claim 1, wherein the substrate comprises a rigid material.

8. The swatch of claim 1, wherein the substrate comprises a material selected from paper, canvas, plastic, cardboard, and poster board.

9. The swatch of claim 1, wherein the substrate is paper that is selected for its ability to resist buckling when a sample is applied to the substrate.

10. The swatch of claim 1, wherein the sample material comprises paint.

11. The swatch of claim 10, wherein the sample material comprises a selected one of a latex paint and a water-based lacquer paint.

12. The swatch of claim 1, wherein the substrate is formed from a material having a texture substantially similar to an intended mounting surface.

13. The swatch of claim 12, wherein the substrate is formed from a material having a texture substantially similar to stucco, concrete, wood, drywall, paper, glass, metal, or fabric.

14. The swatch of claim 1, wherein the repositionable mounting means comprises an adhesive.

15. The swatch of claim 14, wherein the adhesive is tape or glue.

16. The swatch of claim 14, wherein the adhesive is a spray adhesive.

17. The swatch of claim 14, wherein the adhesive covers the entire second surface.

18. The swatch of claim 1, wherein the repositionable mounting means is adapted to mount the substrate to at least one of a wall, a piece of furniture, a cabinet, and a floor.

19. An oversized, repositionable paint swatch comprising:
a flexible paper substrate having a first surface and a second surface, the first surface having a surface area sufficient to achieve a true color characteristic of a paint sample when the paint sample is applied to the first surface and said flexible paper substrate is coupled to a mounting surface, said flexible paper substrate having a width of about 22 inches and a length of about 27 inches;
a sample material applied to the first surface; and
a repositionable mounting adhesive disposed on the second surface and adapted to repositionably couple the flexible paper substrate to the mounting surface.

20. The swatch of claim 19, wherein the flexible paper substrate resists buckling when a paint sample is applied to the flexible paper substrate.
